(19) United States
(12) Patent Application Publication
(10) Pub. No.: US 2017/0180049 A1
(43) Pub. Date: Jun. 22, 2017

(54) APPARATUS AND METHOD FOR BROADCASTING-COMMUNICATIONS CONVERGENCE IN HYBRID FIBER COAX NETWORK

(71) Applicant: ELECTRONICS AND TELECOMMUNICATIONS RESEARCH INSTITUTE, Daejeon (KR)

(72) Inventors: Tae Kyoon KIM, Daejeon (KR); Joon Young JUNG, Daejeon (KR); Dong Joon CHOI, Daejeon (KR); Yong Seong CHO, Daejeon (KR); Nam Ho HUR, Sejong (KR)

(21) Appl. No.: 15/275,280

(22) Filed: Sep. 23, 2016

(30) Foreign Application Priority Data
Dec. 16, 2015 (KR) 10-2015-0180317

(51) Int. Cl. H04B 10/2575; H04N 21/236; H04N 21/458; H04N 21/434; H04N 21/61; H04N 21/438

(52) U.S. Cl. CPC H04B 10/25751; H04N 21/6168; H04N 21/6118; H04N 21/4383; H04N 21/458; H04N 21/434; H04N 21/236

(57) ABSTRACT

Provided are an apparatus and method for broadcasting-communications convergence in a hybrid fiber coax (HFC) network. The apparatus includes an optical connector configured to receive broadcast data and communication data from a cable broadcasting station through an optical cable, a channel switch configured to receive the broadcast data from the optical connector and select a piece of broadcast data to be transmitted to a subscriber from among pieces of the broadcast data, and a convergence processor configured to receive the communication data from the optical io connector, receive the selected piece of broadcast data from the channel switch, generate broadcasting-communications convergence data by multiplexing the received communication data and the selected piece of broadcast data, and transmit the broadcasting-communications convergence data.

### CROSS-REFERENCE TO RELATED APPLICATION(S)

This application claims priority from Korean Patent Application No. 10-2015-0180317, filed on Dec. 16, 2015, in the Korean Intellectual Property Office, the disclosure of which is incorporated herein by reference in its entirety.

### BACKGROUND

1. Field

The following description relates to a cable transmission technology.

2. Description of Related Art

A cable broadcasting system provides a multichannel broadcasting service and a is two-way communications service through a hybrid fiber coax (HFC) network in which an optical cable and a coaxial cable are used together. Data for broadcasting and communications services is classified into a broadcasting band and a communication band and separately modulated with designated frequencies, and the modulated radio frequency (RF) signals are transmitted to cable broadcasting subscribers through an HFC network. According to this transmission method, all broadcast channels are transmitted regardless of whether or not broadcasts are received, and thus frequency resources are wasted. Therefore, there are demands for a transmission technology for efficiently using limited frequency resources.

### SUMMARY

This summary is provided to introduce a selection of concepts in a simplified form that are further described below in the detailed description. This summary is not intended to identify key features or essential features of the claimed subject matter, nor is is it intended to be used as an aid in determining the scope of the claimed subject matter.

The following description relates to an apparatus and method for broadcasting-communications convergence for efficiently using limited resources of a cable transmission system in a hybrid fiber coax (HFC) network.

In one general aspect, an apparatus for broadcasting-communications convergence includes: an optical connector configured to receive broadcast data and communication data from a cable broadcasting station through an optical cable; a channel switch configured to receive the broadcast data from the optical connector and select a piece of broadcast data to be transmitted to a subscriber from among pieces of is the broadcast data; and a convergence processor configured to receive the communication data from the optical connector, receive the selected piece of broadcast data from the channel switch, generate broadcasting-communications convergence data by multiplexing the received communication data and the selected piece of broadcast data, and transmit the broadcasting-communications convergence data.

The channel switch may determine the broadcast channel currently viewed by the subscriber based on viewed channel information, transmit broadcast data of the broadcast channel currently viewed by the subscriber to the convergence processor, and may not transmit broadcast data of broadcast channels currently not viewed by the subscriber to the convergence processor. The channel switch may determine broadcast channels currently viewed by all subscribers in subscriber cells in units of subscriber cells.

The convergence processor may determine, when received data is the communication data, whether to use an existing communications channel, output, when s it is determined to use the existing communications channel, the communication data through the existing communications channel, multiplex the output communication data with the selected piece of broadcast data, and transmit the multiplexed data.

The convergence processor may determine, when received data is the communication data, whether to use an existing communications channel, output, when io it is determined not to use the existing communications channel, the communication data through one of existing broadcast channels through which no broadcast data is transmitted, multiplex the output communication data with the selected piece of broadcast data, and transmit the multiplexed data.

The convergence processor may determine, when received data is the is broadcast data, whether the broadcast data is data of a channel selected by a viewer, output, when the broadcast data is data of the channel selected by the viewer, the broadcast data through an existing broadcast channel, multiplex the output broadcast data with the communication data, and transmit the multiplexed data.

The convergence processor may determine, when received data is the broadcast data, whether the broadcast data is data of a channel selected by a viewer, output, when the broadcast data is not data of the channel selected by the viewer, the communication data through one of existing broadcast channels through which no broadcast data is transmitted, multiplex the output communication data with the communication data, and transmit the multiplexed data.

The convergence processor may transmit the communication data by considering a transmission schedule of a communication channel. The convergence processor may transmit the multiplexed broadcasting-communications convergence data through a broadcasting-communications convergence channel. The convergence processor may transmit the selected piece of broadcast data and the communication data using an identical transmission protocol.

The apparatus may further include a controller configured to control the channel switch to select broadcast data corresponding to a channel currently viewed by the subscriber using subscriber viewing information of a subscriber terminal. The controller may receive a subscriber viewing information message including viewer information and viewed channel information from the subscriber terminal, the viewer information may include subscriber cell information, and the viewed channel information may include information on whether or not a broadcast is viewed and viewed broadcast channel information.

The controller may receive subscriber viewing information from the subscriber terminal to determine whether there is a broadcast channel currently selected by a viewer, update broadcast channel information of a viewed channel and unviewed channels, and control switching of the channel switch so that the channel switch selects broadcast data of the viewed broadcast channel.

The controller may transmit a cell viewing information message including viewed channel information of channels currently viewed by subscribers in a subscriber cell and subscriber cell information to the channel switch, and the viewed channel information may include information on broadcast channels newly selected by subscribers and information on broadcast channels still being viewed.

The apparatus may further include an output processor configured to receive the broadcasting-communications convergence data generated by the convergence processor, frequency modulate the broadcasting-communications convergence data, and output a frequency-modulated radio frequency (RF) signal to a subscriber terminal in a subscriber cell through a coaxial cable.

The apparatus may be located at a cell node or a headend.

In another general aspect, a method for broadcasting-communications convergence in an HFC network includes: receiving, by a broadcasting-communications convergence apparatus, broadcast data and communication data from a cable io broadcasting station through an optical cable; selecting a piece of broadcast data to be transmitted to a subscriber from among pieces of the broadcast data; and generating broadcasting-communications convergence data by multiplexing the received communication data and the selected piece of broadcast data, and transmitting the broadcasting-communications convergence data.

The selecting of the piece of broadcast data may include: determining a broadcast channel currently viewed by the subscriber based on viewed channel information; and transmitting broadcast data of the broadcast channel currently viewed by the subscriber, and transmitting no broadcast data of broadcast channels not currently viewed by the subscriber.

The generating and transmitting of the broadcasting-communications convergence data may include: when received data is the communication data, determining whether to use an existing communications channel, outputting, when it is determined to use the existing communications channel, the communication data through the existing communications channel, and outputting, when it is determined not to use the existing communications channel, the communication data through one of existing broadcast channels through which no broadcast data is transmitted; and multiplexing the output communication data with the selected piece of broadcast data, and transmitting the multiplexed data.

The generating and transmitting of the broadcasting-communications convergence data may include: when received data is the broadcast data, determining whether the broadcast data is data of a channel selected by a viewer, outputting, when the broadcast data is data of the channel selected by the viewer, the broadcast data through an existing broadcast channel, and outputting, when the broadcast data is not io data of the channel selected by the viewer, the communication data through one of existing broadcast channels through which no broadcast data is transmitted; and multiplexing the communication data with the broadcast data, and transmitting the multiplexed data.

Other features and aspects will be apparent from the following detailed is description, the drawings, and the claims.

### BRIEF DESCRIPTION OF THE DRAWINGS

FIG. 1 shows a configuration of a hybrid fiber coax (HFC)-based cable transmission system.

FIG. 2 is a frequency distribution diagram showing an example of cable network frequency assignment of the cable transmission system.

FIG. 3 shows a configuration of a cable transmission system for broadcasting-communications convergence according to an exemplary embodiment of the present invention.

FIG. 4 is a detailed block diagram of a broadcasting-communications convergence apparatus shown in FIG. 3 according to an exemplary embodiment of the present invention.

FIG. 5 is a structure diagram of a subscriber viewing information message received from a subscriber terminal by a controller according to an exemplary embodiment of the present invention.

FIG. 6 is a flowchart illustrating an operation process of the controller according to an exemplary embodiment of the present invention.

FIG. 7 is a structure diagram of a cell viewing information message transmitted to io a channel switch by the controller according to an exemplary embodiment of the present invention.

FIG. 8 is a conceptual diagram illustrating a principle of broadcast channel switching of the channel switch according to an exemplary embodiment of the present invention.

FIG. 9 is a flowchart illustrating an operation process of the channel switch according to an exemplary embodiment of the present invention.

FIG. 10 is a structure diagram of a transmission protocol according to an exemplary embodiment of the present invention.

FIG. 11 is a flowchart illustrating a process of a convergence processor according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, exemplary embodiments of the present invention will be described in detail with reference to the accompanying drawings. In the following description of the present invention, a detailed description of known art related to the present invention will be omitted when determined to unnecessarily obscure the subject matter of the present invention. Also, the terms used in the following description are terms defined in consideration of functions in exemplary embodiments of the present invention and may vary depending on a user's or an operator's intention, practice, or so on. Therefore, definitions of terms used herein should be made based on the content throughout the specification.

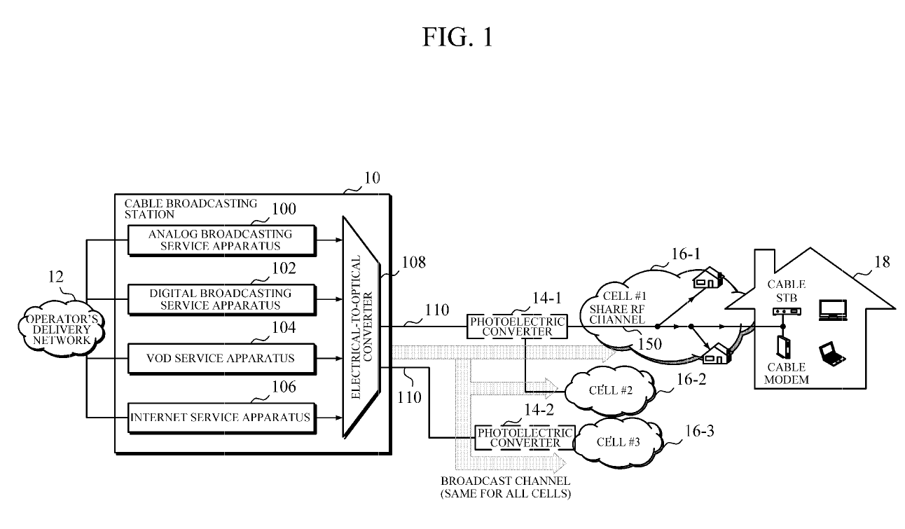

FIG. 1 shows a configuration of a hybrid fiber coax (HFC)-based cable transmission system.

Referring to FIG. 1, a general HFC-based cable transmission system includes a is cable broadcasting station 10 which is a system operator (SO), an optical cable 110, photoelectric converters 14-1 and 14-2, a coaxial cable 150, subscriber cells 16-1, 16-2, and 16-3, and subscriber terminals 18.

Based on an HFC, the cable broadcasting station 10 includes an analog broadcasting service apparatus 100 which provides an analog broadcasting service, a digital broadcasting service apparatus 102 which provides a digital broadcasting service, a video on demand (VoD) service apparatus 104 which provides a VoD service, an Internet service apparatus 106 which provides Internet services such as a two-way Internet service, a voice over Internet protocol (VoIP) service, etc., and an electrical-to-optical converter 108 which performs radio frequency (RF) combining of signals transmitted through the respective apparatuses 100, 102, 104, and 106, performs an electrical-to-optical conversion of a resultant RF signal, and transmits the RF signal in the form of an optical signal. The cable broadcasting station 10 may simultaneously provide a broadcasting service and a communications service through a wired broadband network.

The photoelectric converters 14-1 and 14-2 located at points of contact between an optical section and coaxial sections receive the optical signal and perform a photoelectric conversion of the optical signal. After the photoelectric conversion, the RF signal is down converted to a cable frequency band, and the down-converted RF io signal is transmitted to subscriber terminals 18 in each of the subscriber cells 16-1, 16-2, and 16-3. The subscriber terminals 18 receive desired signals by demodulating frequency channel signals according to subscribers, thereby receiving services.

In the cable transmission system described above with reference to FIG. 1, all of the broadcast channel data of the cable broadcasting station 10 is transmitted to the is subscriber cells 16-1, 16-2, and 16-3 of all regions connected to the cable broadcasting station 10. In this case, even when viewers do not actually view any broadcast, the frequency band is occupied, and thus frequency resources are wasted.

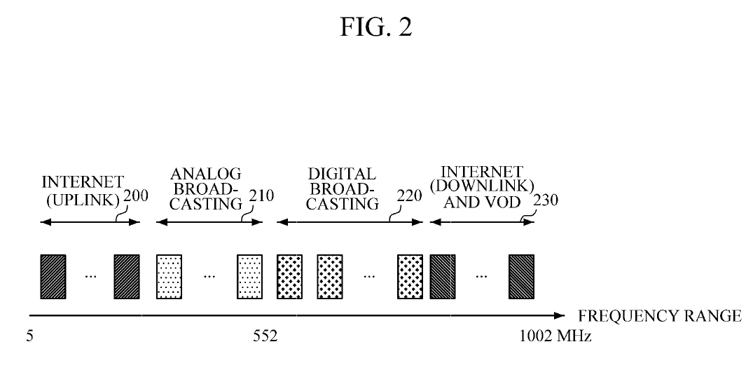

FIG. 2 is a frequency distribution diagram showing an example of cable network frequency assignment of the cable transmission system.

Referring to FIG. 2, the broadcasting service and the communications service of the cable transmission system assign unique frequencies to subscribers in the subscriber cells of all regions connected to the cable transmission system. For example, as shown in FIG. 2, each of an Internet (uplink) service 200, an analog broadcasting service 210, a digital broadcasting service 220, and an Internet (downlink) service 230 has a unique frequency range.

According to a transmission method of such a cable transmission system, all of the broadcast channel data is transmitted regardless of whether or not broadcasts are s viewed by viewers. This results in waste of cable frequencies. To meet requirements of a high-capacity broadcasting service for an ultra high definition (UHD) television (TV), etc. and provide a high-speed communications service, a transmission method for efficiently using limited frequency resources of a cable transmission system is necessary.

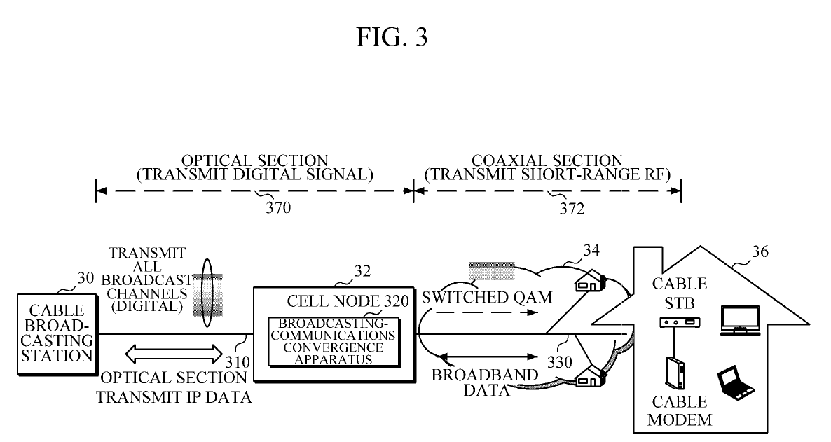

FIG. 3 shows a configuration of a cable transmission system for broadcasting-communications convergence according to an exemplary embodiment of the present invention.

Referring to FIG. 3, a cable transmission system for broadcasting-communications convergence includes a cable broadcasting station 30, a broadcasting-communications convergence apparatus 320, a subscriber cell 34, and a subscriber terminal 36. As shown in FIG. 3, the broadcasting-communications convergence apparatus 320 may be located at a cell node 32. In another example, the broadcasting-communications convergence apparatus 320 may be located at the headend which is a transmission service providing spot of an operator.

In the HFC-based cable transmission system for broadcasting-communications convergence, the cable broadcasting station 30 does not transmit an RF signal including broadcast data and communication data, but the broadcasting-communications convergence apparatus 320 which is a point of contact between an optical section 370 and a coaxial section 372 in an HFC network transmits the RF signal to the subscriber terminal 36 in the subscriber cell 34.

The HFC network includes the optical section 370 between the cable broadcasting station 30 and the coaxial section 372 connected through an optical cable 310, and the coaxial section 372 between the cell node 32 and the subscriber terminal 36 connected through a coaxial cable 330. In the optical section 370, all broadcast and communication data of the cable broadcasting station 30 is transmitted to the broadcasting-communications convergence apparatus 320 through the optical cable 310. In the coaxial section 372, an RF signal obtained by converging data of a broadcast actually viewed by a subscriber and communication data is transmitted to the subscriber terminal 36 via a two-way communication with the subscriber terminal 36. By reducing unnecessary transmission of data of broadcasts not viewed by the subscriber and transmitting the communication data in the remaining frequency band, bandwidth for data communication is additionally ensured, so that efficiency in the use of cable frequency resources is improved.

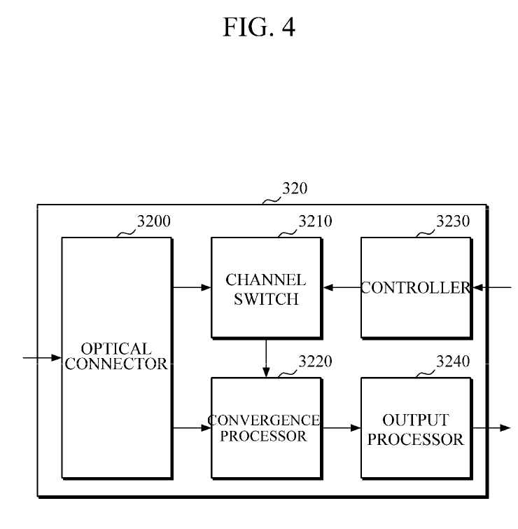

FIG. 4 is a detailed block diagram of the broadcasting-communications convergence apparatus shown in FIG. 3 according to an exemplary embodiment of the present invention.

Referring to FIGS. 3 and 4, the broadcasting-communications convergence apparatus 320 includes an optical connector 3200, a channel switch 3210, a convergence processor 3220, a controller 3230, and an output processor 3240. The optical connector 3200 of the broadcasting-communications convergence apparatus 320 may be implemented by a communications module which transmits and receives data, and the channel switch 3210, the convergence processor 3220, the controller 3230, and the output processor 3240 may be implemented by a processor. It is possible to further include a memory for storing information for the processor to perform operations.

The optical connector 3200 receives broadcast data transmitted from the cable broadcasting station 30 and communication data through the optical cable 310, transmits the broadcast data to the channel switch 3210, and transmits the communication data to the convergence processor 3220.

The channel switch 3210 receives the broadcast data from the optical connector 3200 and selects a piece of broadcast data to be transmitted to the subscriber from io among pieces of the broadcast data. To select a piece of broadcast data, viewed channel information with which it is possible to determine the broadcast channel currently viewed by the subscriber may be used, and the viewed channel information may be received from the controller 3230.

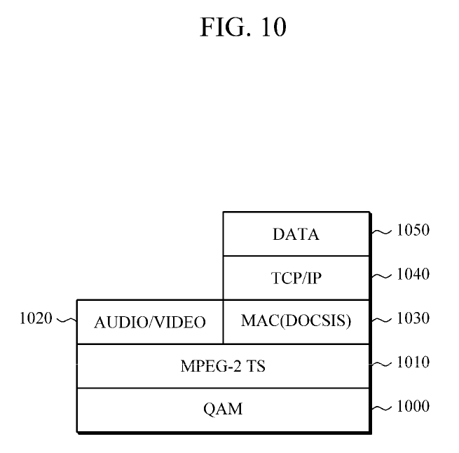

The convergence processor 3220 receives the communication data from the is optical connector 3200 and receives the selected piece of broadcast data from the channel switch 3210, generates broadcasting-communications convergence data by multiplexing the received communication data and the selected piece of broadcast data, and transmits the broadcasting-communications convergence data. The convergence processor 3220 may transmit the communication data by considering a transmission schedule of a communication channel. The convergence processor 3220 may transmit the multiplexed broadcasting-communications convergence data through a broadcasting-communications convergence channel. The convergence processor 3220 may transmit the selected piece of broadcast data and the communication data using an identical transmission protocol. The transmission protocol will be described below with reference to FIG. 10.

The output processor 3240 receives the broadcasting-communications convergence data generated by the convergence processor 3220, frequency modulates s the broadcasting-communications convergence data, and outputs a frequency-modulated RF signal to the subscriber terminal 36 in the subscriber cell 34 through the coaxial cable 330.

The controller 3230 receives information on broadcast channels selected by viewers via a two-way communication with all subscriber terminals in subscriber cells io and controls an operation of the channel switch 3210 so that broadcast data of the broadcast channels may be transmitted.

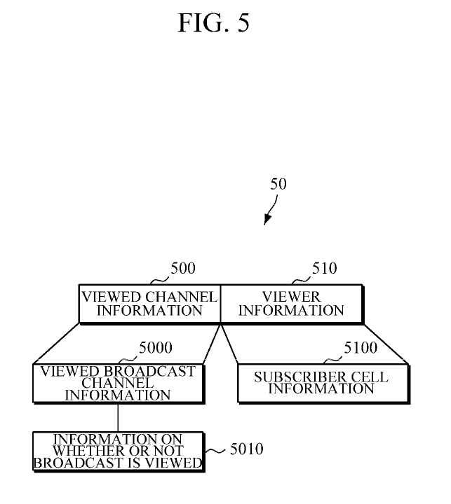

FIG. 5 is a structure diagram of a subscriber viewing information message received from a subscriber terminal by a controller according to an exemplary embodiment of the present invention.

Referring to FIGS. 4 and 5, the controller 320 receives a subscriber viewing information message 50 including viewer information 510 and viewed channel information 500 from a subscriber terminal. The viewer information 510 includes subscriber cell information 5100, and the viewed channel information 500 includes information 5010 on whether or not a broadcast is viewed and viewed broadcast channel information 5100. The subscriber cell information 5100 indicates a cell to which a subscriber currently belongs. In cable broadcasting, a subscriber cell is a set of a predetermined number of subscriber terminals and is a base unit for transmission. The number of subscribers per cell may vary according to operational policies of operators, such as SOs, multiple system operators (MSOs), or so on. The subscriber viewing information message 50 is processed in units of subscribers. During a particular period of time, the number of channels that may be viewed by a viewer should not be more than one.

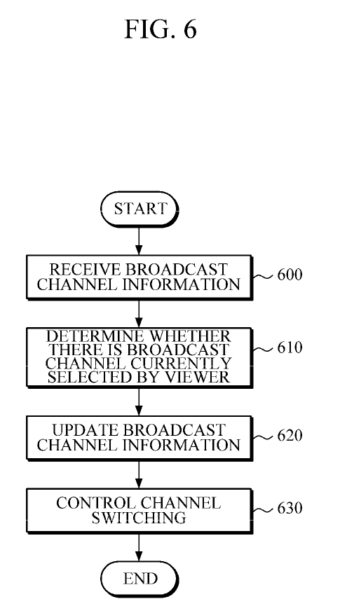

FIG. 6 is a flowchart illustrating an operation process of the controller according s to an exemplary embodiment of the present invention.

Referring to FIGS. 4 and 6, the controller 3230 receives broadcast channel information in real time (600) and determines whether there is a broadcast channel currently selected by a viewer (610). Subsequently, the controller 3230 updates broadcast channel information of a viewed channel and unviewed channels (620). To io this end, the controller 3230 should be able to acquire information on a broadcast channel selected by the viewer in real time. Also, the controller 2320 should be able to update the information on a broadcast channel selected by the viewer in real time. Subsequently, the controller 3230 controls channel switching of the channel switch 3210 using the broadcast channel information (630).

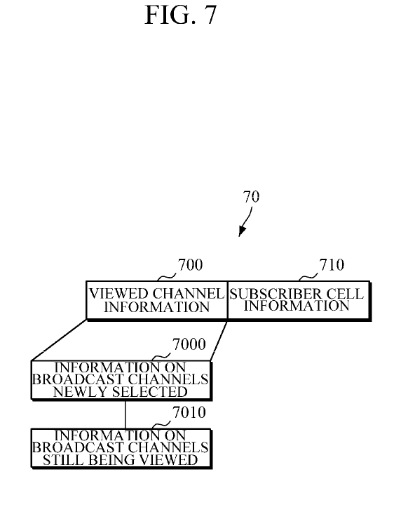

FIG. 7 is a structure diagram of a cell viewing information message transmitted to a channel switch by the controller according to an exemplary embodiment of the present invention.

Referring to FIGS. 4 and 7, the controller 3230 transmits, to the channel switch 3210, a cell viewing information message 70 including viewed channel information 700 which is information on channels currently viewed by subscribers in a subscriber cell and subscriber cell information 710. The viewed channel information 700 may include information 7000 on broadcast channels newly selected by subscribers and information 7010 on broadcast channels still being viewed.

The cell viewing information message 70 may be processed in units of cells. The controller 3230 transmits information on all channels currently viewed in the subscriber cell to the channel switch 3210. The viewed channel information 700 indicates all channels viewed at a current point in time and including channels which are still being viewed by subscribers selecting previous broadcast channels and channels which are newly selected and viewed by subscribers. Channels viewed in the subscriber cell have been selected not by viewers but by subscribers in the subscriber cell, and thus overlapping channels are represented as one channel. The maximum number of channels represents a case in which all the subscribers have selected different channels and thus may be all channels which may be transmitted in the subscriber cell.

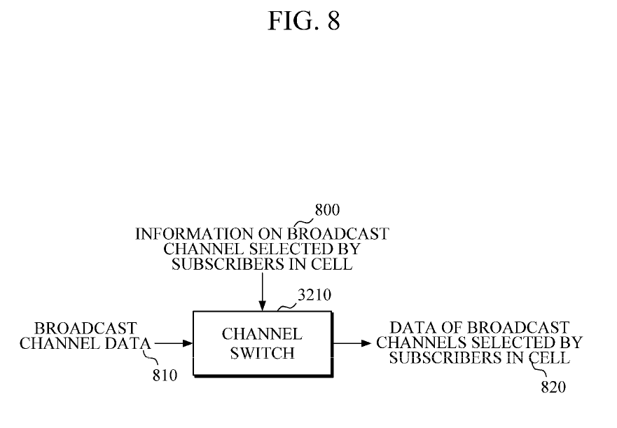

FIG. 8 is a conceptual diagram illustrating a principle of broadcast channel switching of the channel switch according to an exemplary embodiment of the present invention.

Referring to FIGS. 4 and 8, the channel switch 3210 transmits only data 820 of broadcast channels selected by subscribers in a subscriber cell from RF-based broadcast channel data 810 to the convergence processor 3220 using broadcast channel information 800 received from the controller 3230 and selected by the subscribers in the subscriber cell, and does not transmit the remaining broadcast channel data.

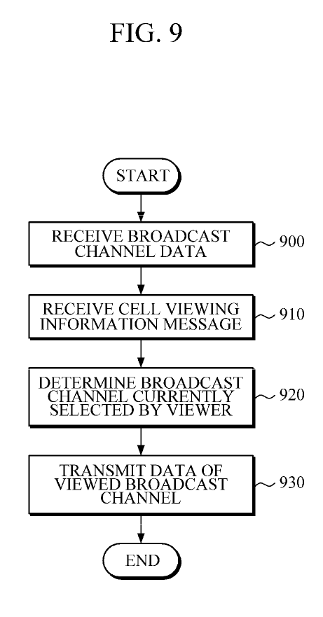

FIG. 9 is a flowchart illustrating an operation process of the channel switch according to an exemplary embodiment of the present invention.

Referring to FIGS. 4 and 9, the channel switch 3210 receives broadcast channel data from the optical connector 3200 (900) and receives a cell viewing information message from the controller 3230 (910). The channel switching unit 3210 determines a broadcast channel which is selected and currently viewed by a viewer using the cell viewing information message (920). At this time, the channel switch 3210 transmits data of the viewed broadcast channel to the convergence processor 3220 and assigns s the unviewed broadcast channels for communication (930).

To this end, the channel switch 3210 should be able to distinguish packets of a broadcast channel selected by a viewer. Also, the channel switch 3210 should be able to transmit only packets of a broadcast channel selected by a viewer. Further, the channel switch 3210 should be able not to transmit packets of broadcast channels not io selected by a viewer.

FIG. 10 is a structure diagram of a transmission protocol according to an exemplary embodiment of the present invention.

Referring to FIGS. 4 and 10, the convergence processor 3220 does not transmit broadcast data and communication data using different protocols but defines and is multiplexes broadcast data and communication data as one protocol stack, as shown in FIG. 10. Broadcast data has a Moving Picture Experts Group (MPEG)-2 transport stream (TS) layer 1010 on a quadrature amplitude modulation (QAM) physical layer 1000 and has video and audio data 1020 on the MPEG-2 TS layer 1010. Communication data has the MPEG-2 TS layer 1010 on the QAM physical layer 1000, has a data over cable service interface specifications (DOCSIS) media access control (MAC) layer 1030 and a transmission control protocol (TCP)/Internet protocol (IP) layer 1040 on the MPEG-2 TS layer 1010, and has data 1050 on the TCP/IP layer 1040.

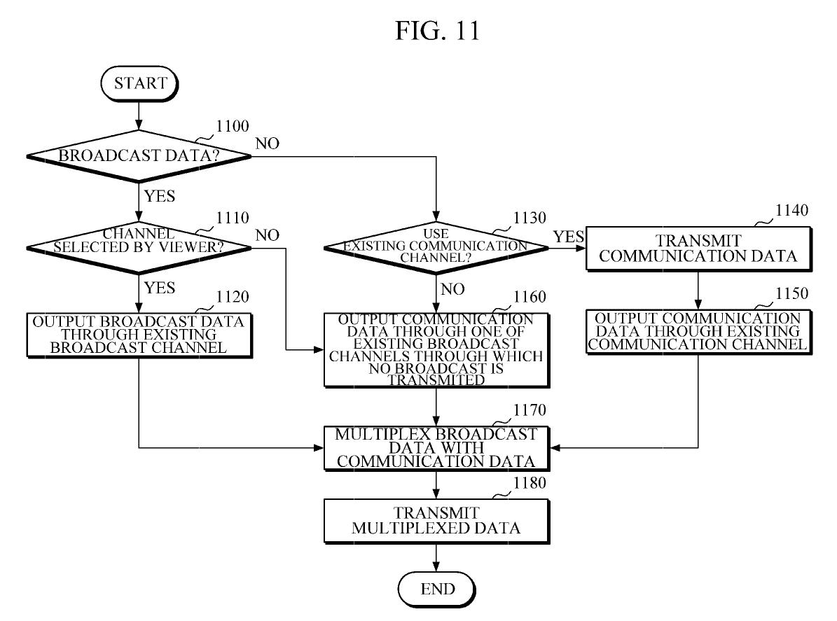

FIG. 11 is a flowchart illustrating a process of a convergence processor according to an exemplary embodiment of the present invention.

Referring to FIGS. 4 and 11, the convergence processor 3220 determines whether received data is communication data (1100). When the received data is communication data, the convergence processor 3220 determines whether to use an existing communication channel (1130). When it is determined to use the existing communication channel, the convergence processor 3220 transmits the communication data (1140) and outputs the communication data through the communication channel (1150). Then, the convergence processor 3220 multiplexes the output communication data with broadcast data (1170) and transmits the multiplexed data (1180). On the other hand, when it is determined that the existing communication channel is not used io by the received communication data, the convergence processor 3220 outputs the communication data through a broadcast channel through which no broadcast data is transmitted among existing broadcast channels (1160), multiplexes the output communication data with the broadcast data (1170), and transmits the multiplexed data (1180).

When the received data is broadcast data (1100), the convergence processor 3220 according to an exemplary embodiment determines whether the broadcast data is data of a channel selected by a viewer (1110). When the broadcast data is data of a channel selected by a viewer, the convergence processor 3220 outputs the broadcast data through an existing broadcast channel (1120), multiplexes the output broadcast data with the communication data (1170), and transmits the multiplexed data (1180). On the other hand, when the broadcast data is not data of the channel selected by the viewer, the convergence processor 3220 outputs the communication data through a broadcast channel through which no broadcast data is transmitted among the existing broadcast channels (1160), multiplexes the output communication data with the broadcast data (1170), and transmits the multiplexed data (1180).

To this end, the convergence processor 3220 should be able to generate a converged transmission data stream by multiplexing a broadcast data stream and a communication data stream. Also, the convergence processor 3220 should be able to multiplex a broadcast data stream with a higher priority over a communication data stream, and an input data format of a QAM modulator should be able to support MPEG-2 TS. The convergence processor 3220 should be able to transmit a selected broadcast channel. The convergence processor 3220 should be able to transmit a io communication data stream by considering a transmission schedule of each physical channel. Also, for a communication data service, the convergence processor 3220 should be able to support a channel fusing function.

According to an exemplary embodiment, it is possible to efficiently use a frequency band while transmitting broadcast data and communication data. In is particular, to efficiently use limited frequency resources of an HFC-based cable transmission system, only broadcast channels which are actually viewed in a subscriber cell are transmitted, and communication data is also transmitted in the remaining frequency band, so that efficiency in the use of cable frequency resources may be improved. Further, it is possible to simply construct and manage a cable transmission system.

A number of examples have been described above. Nevertheless, it will be understood that various modifications may be made. For example, suitable results may be achieved if the described techniques are performed in different order and/or if components in a described system, architecture, device, or circuit are combined in a different manner and/or replaced or supplemented by other components or their equivalents. Accordingly, other implementations are within the scope of the following claims.

What is claimed is:

1. An apparatus for broadcasting-communications convergence comprising:
an optical connector configured to receive broadcast data and communication data from a cable broadcasting station through an optical cable;
a channel switch configured to receive the broadcast data from the optical connector and select a piece of broadcast data to be transmitted to a subscriber from among pieces of the broadcast data;
a convergence processor configured to receive the communication data from the io optical connector, receive the selected piece of broadcast data from the channel switch, generate broadcasting-communications convergence data by multiplexing the received communication data and the selected piece of broadcast data, and transmit the broadcasting-communications convergence data.

2. The apparatus of claim 1, wherein the channel switch determines a broadcast channel currently viewed by the subscriber based on viewed channel information, transmits broadcast data of the broadcast channel currently viewed by the subscriber to the convergence processor, and does not transmit broadcast data of broadcast channels currently not viewed by the subscriber to the convergence processor.

3. The apparatus of claim 1, wherein the channel switch determines broadcast channels currently viewed by all subscribers in subscriber cells in units of subscriber cells.

4. The apparatus of claim 1, wherein the convergence processor determines, when received data is the communication data, whether to use an existing communications channel, outputs, when it is determined to use the existing communications channel, the communication data through the existing communications channel, multiplexes the output communication data with the selected piece of broadcast data, and transmits the multiplexed data.

5. The apparatus of claim 1, wherein the convergence processor determines, when received data is the communication data, whether to use an existing io communications channel, outputs, when it is determined not to use the existing communications channel, the communication data through one of existing broadcast channels through which no broadcast data is transmitted, multiplexes the output communication data with the selected piece of broadcast data, and transmits the multiplexed data.

6. The apparatus of claim 1, wherein the convergence processor determines, when received data is the broadcast data, whether the broadcast data is data of a channel selected by a viewer, outputs, when the broadcast data is data of the channel selected by the viewer, the broadcast data through an existing broadcast channel, multiplexes the output broadcast data with the communication data, and transmits the multiplexed data.

7. The apparatus of claim 1, wherein the convergence processor determines, when received data is the broadcast data, whether the broadcast data is data of a channel selected by a viewer, outputs, when the broadcast data is not data of the channel selected by the viewer, the communication data through one of existing broadcast channels through which no broadcast data is transmitted, multiplexes the output communication data with communication data, and transmits the multiplexed data.

8. The apparatus of claim 1, wherein the convergence processor transmits the communication data by considering a transmission schedule of a communication channel.

9. The apparatus of claim 1, wherein the convergence processor transmits the multiplexed broadcasting-communications convergence data through a broadcasting-communications convergence channel.

10. The apparatus of claim 1, wherein the convergence processor transmits the selected piece of broadcast data and the communication data using an identical transmission protocol.

11. The apparatus of claim 1, further comprising a controller configured to control the channel switch to select broadcast data corresponding to a channel currently viewed by the subscriber using subscriber viewing information of a subscriber terminal.

12. The apparatus of claim 11, wherein the controller receives a subscriber viewing information message including viewer information and viewed channel information from the subscriber terminal,
the viewer information includes subscriber cell information, and
the viewed channel information includes information on whether or not a broadcast is viewed and viewed broadcast channel information.

13. The apparatus of claim 11, wherein the controller receives subscriber viewing information from the subscriber terminal to determine whether there is a broadcast channel currently selected by a viewer, updates broadcast channel information of a viewed channel and unviewed channels, and controls switching of the channel switch so that the channel switch selects broadcast data of the viewed broadcast channel.

14. The apparatus of claim 11, wherein the controller transmits a cell viewing information message including viewed channel information of channels currently viewed by subscribers in a subscriber cell and subscriber cell information to the channel switch, and
the viewed channel information includes information on broadcast channels newly selected by subscribers and information on broadcast channels still being viewed.

15. The apparatus of claim 1, further comprising an output processor configured to receive the broadcasting-communications convergence data generated by the convergence processor, frequency modulate the broadcasting-communications convergence data, and output a frequency-modulated radio frequency (RF) signal to a subscriber terminal in a subscriber cell through a coaxial cable.

16. The apparatus of claim 1, wherein the apparatus is located at a cell node or a headend.

17. A method for broadcasting-communications convergence in a hybrid fiber coax (HFC) network, the method performed by a broadcasting-communications convergence apparatus and comprising:
receiving broadcast data and communication data from a cable broadcasting station through an optical cable;
selecting a piece of broadcast data to be transmitted to a subscriber from among pieces of the broadcast data; and
generating broadcasting-communications convergence data by multiplexing the is received communication data and the selected piece of broadcast data, and transmitting the broadcasting-communications convergence data.

18. The method of claim 17, wherein the selecting of the piece of broadcast data includes:
determining a broadcast channel currently viewed by the subscriber based on viewed channel information; and
transmitting broadcast data of the broadcast channel currently viewed by the subscriber, and transmitting no broadcast data of broadcast channels not currently viewed the subscriber.

19. The method of claim 17, wherein the generating and transmitting of the broadcasting-communications convergence data include:
when received data is the communication data, determining whether to use an existing communications channel, outputting, when it is determined to use the existing communications channel, the communication data through the existing communications channel, and outputting, when it is determined not to use the existing communications channel, the communication data through one of existing broadcast channels through which no broadcast data is transmitted; and
multiplexing the output communication data with the selected piece of broadcast data, and transmitting the multiplexed data.

20. The method of claim 17, wherein the generating and transmitting of the broadcasting-communications convergence data include:
when received data is the broadcast data, determining whether the broadcast data is data of a channel selected by a viewer, outputting, when the broadcast data is data of the channel selected by the viewer, the broadcast data through an existing broadcast channel, and outputting, when the broadcast data is not data of the channel selected by the viewer, the communication data through one of existing broadcast channels through which no broadcast data is transmitted; and
multiplexing the communication data with the broadcast data, and transmitting the multiplexed data.
